(19) United States
(12) Patent Application Publication
(10) Pub. No.: US 2023/0019759 A1
(43) Pub. Date: Jan. 19, 2023

(54) VIBRATING DEVICE

(71) Applicant: Murata Manufacturing Co., Ltd., Nagaokakyo-shi (JP)

(72) Inventors: Tomoya KITAGAWA, Nagaokakyo-shi (JP); Kenji KAGAYAMA, Nagaokakyo-shi (JP); Hiroyuki KISHISHITA, Nagaokakyo-shi (JP); Katsuhiro ONISHI, Nagaokakyo-shi (JP); Shogo TOKOI, Nagaokakyo-shi (JP)

(21) Appl. No.: 17/955,602

(22) Filed: Sep. 29, 2022

Related U.S. Application Data
(63) Continuation of application No. PCT/JP2021/004599, filed on Feb. 8, 2021.

(30) Foreign Application Priority Data
Apr. 6, 2020 (JP) 2020-068109

(51) Int. Cl. B06B 1/06

(52) U.S. Cl. CPC B06B 1/0603

(57) ABSTRACT

A vibrating device includes a first case, a second case joined to the first case, flexible bodies each including a free end, piezoelectric elements attached to the respective flexible bodies, and a mass joined to the flexible bodies. The first case has a flat plate shape. The second case includes a bottom and a lateral wall. The vibrating device further includes holder in contact with the first case, the lateral wall, and the bottom.

### CROSS REFERENCE TO RELATED APPLICATIONS

This application claims the benefit of priority to Japanese Patent Application No. 2020-068109 filed on Apr. 6, 2020 and is a Continuation Application of PCT Application No. PCT/JP2021/004599 filed on Feb. 8, 2021. The entire contents of each application are hereby incorporated herein by reference.

### BACKGROUND OF THE INVENTION

### 1. Field of the Invention

The present invention relates to a vibrating device.

### 2. Description of the Related Art

A vibrating device disclosed in WO2019/044958A1 is to be included in a communication apparatus such as a smartphone and is intended for the notification of incoming information. The vibrating device includes a supporting member, a first displaceable plate, a second displaceable plate, a first piezoelectric vibrating element, a second piezoelectric vibrating element, a mass-adding member, a first casing member, and a second casing member. The supporting member includes a first side portion and a second side portion that are located opposite each other. The first displaceable plate is supported by the supporting member while having a free end. The second displaceable plate is supported by the supporting member while having a free end. The first piezoelectric vibrating element is provided on the first displaceable plate. The second piezoelectric vibrating element is provided on the second displaceable plate. The mass-adding member is connected to a portion of the first displaceable plate that is at the free end and to a portion of the second displaceable plate that is at the free end. The supporting member is located between the first casing member and the second casing member. The first casing member, the second casing member, and the supporting member are assembled into a case, in which the first displaceable plate, the second displaceable plate, the first piezoelectric vibrating element, the second piezoelectric vibrating element, and the mass-adding member are housed.

### SUMMARY OF THE INVENTION

In the vibrating device disclosed by WO2019/044958A1, the strength at the joint between the first casing member and the supporting member and the joint between the supporting member and the second casing member may be reduced if any impact is applied to the vibrating device in a situation such as when the vibrating device is dropped or when the mass-adding member comes into contact with the second casing member with the vibration of the displaceable plates. That is, the mechanical strength of the case is insufficient.

Preferred embodiments of the present invention provide vibrating devices each including a case having an excellent mechanical strength.

A vibrating device according to a preferred embodiment of the present invention includes a first case, a second case joined to the first case, a flexible body including a free end, a piezoelectric element attached to the flexible body, and a mass joined to the flexible body. The first case has a flat plate shape. The second case includes a bottom and a lateral wall. The vibrating device further includes a holder in contact with the first case, the lateral wall, and the bottom.

According to preferred embodiments of the present invention, vibrating devices each including a case having an excellent mechanical strength are provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a vibrating device according to a first preferred embodiment of the present invention.

FIG. 2 is an exploded perspective view of the vibrating device according to the first preferred embodiment of the present invention.

FIG. 3 is a plan view of a first flexible member, a second flexible member, and a supporting member included in the vibrating device according to the first preferred embodiment of the present invention.

FIG. 4 is a perspective view of a mass member included in the vibrating device according to the first preferred embodiment of the present invention.

FIG. 5 is a front view of the mass member included in the vibrating device according to the first preferred embodiment of the present invention.

FIG. 6 is a partially sectional perspective view of the vibrating device according to the first preferred embodiment of the present invention.

FIGS. 7A and 7B are a front view and a plan view, respectively, of the vibrating device according to the first preferred embodiment of the present invention.

FIG. 8 is an exploded perspective view of the vibrating device according to the first preferred embodiment of the present invention.

FIG. 9 is a sectional side view of a portion of the vibrating device according to the first preferred embodiment of the present invention.

FIG. 10 is a perspective view of a first member to be used in manufacturing the vibrating device according to the first preferred embodiment of the present invention.

FIG. 11 is a perspective view of a second member to be used in manufacturing the vibrating device according to the first preferred embodiment of the present invention.

FIG. 12 is a perspective view of a third member to be used in manufacturing the vibrating device according to the first preferred embodiment of the present invention.

FIG. 13 is a perspective view of a vibrating device according to a second preferred embodiment of the present invention.

FIG. 14 is a perspective view of a vibrating device according to a third preferred embodiment of the present invention.

FIG. 15A is a perspective view of a vibrating device according to a fourth preferred embodiment of the present invention, FIG. 15B is a sectional view of a portion along line A-A′ illustrated in FIG. 15A, and FIG. 15C is a sectional view of a portion along line B-B′ illustrated in FIG. 15A.

FIG. 16A is a perspective view of a vibrating device according to a fifth preferred embodiment of the present invention, and FIG. 16B is a sectional view of a portion along line C-C′ illustrated in FIG. 16A.

FIGS. 17A to 17D are each a sectional view of a portion of a vibrating device according to a variation of the present invention.

### DETAILED DESCRIPTION OF THE PREFERRED EMBODIMENTS

The present invention will now be disclosed by describing specific preferred embodiments thereof with reference to the drawings.

It should be noted that the preferred embodiments to be described in this specification are only exemplary and that any replacement or combination of relevant elements is possible between different preferred embodiments.

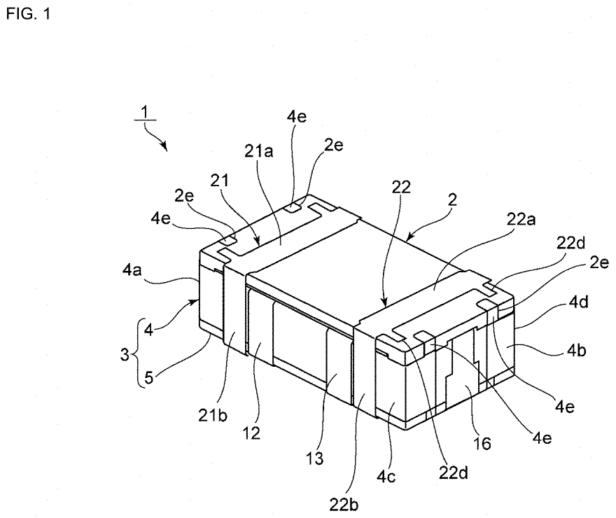

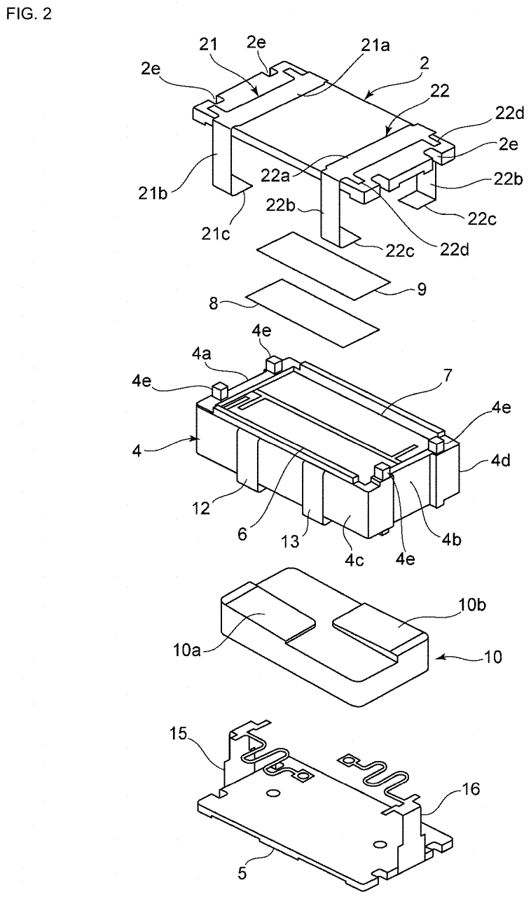

FIG. 1 is a perspective view of a vibrating device according to a first preferred embodiment of the present invention. FIG. 2 is an exploded perspective view of the vibrating device according to the first preferred embodiment of the present invention.

The vibrating device, 1, according to the first preferred embodiment of the present invention includes a first case member 2 and a second case member 3. The first case member 2 and the second case member 3 are assembled into a case. The first case member 2 is made of synthetic resin. The first case member 2 has a flat plate shape. The first case member 2 according to the first preferred embodiment is not specifically limited but has a rectangular plate shape.

The second case member 3 includes a lateral wall member 4 and a bottom member 5. The bottom member 5 has a rectangular plate shape. The lateral wall member 4 has an annular shape with two openings located opposite each other. An end of the lateral wall member 4 that is at one of the openings is joined to the bottom member 5. Thus, the second case member 3 is obtained. The one opening of the lateral wall member 4 is closed by the bottom member 5. The lateral wall member 4 and the bottom member 5 are each made of synthetic resin. The first case member 2 and the second case member 3 may each be made of an insulative material other than synthetic resin.

An end of the lateral wall member 4 that is at the other opening is joined to the first case member 2. Thus, a cuboidal case is obtained. The other opening of the lateral wall member 4 is closed by the first case member 2. The combination of the first case member 2 and the second case member 3 provides a housing space.

The vibrating device 1 includes a first flexible member 6 and a second flexible member 7. The first flexible member 6 and the second flexible member 7 are provided in the housing space. The first flexible member 6 and the second flexible member 7 each have an oblong rectangular plate shape. The first flexible member 6 and the second flexible member 7 are each made of an elastic material such as metal.

The vibrating device 1 includes a first piezoelectric element 8 and a second piezoelectric element 9. The first piezoelectric element 8 is attached to the first flexible member 6. The second piezoelectric element 9 is attached to the second flexible member 7.

The lateral wall member 4 includes a first lateral wall 4a, a second lateral wall 4b, a third lateral wall 4c, and a fourth lateral wall 4d. The first lateral wall 4a and the second lateral wall 4b are located opposite each other and extend parallel to each other. The third lateral wall 4c and the fourth lateral wall 4d are located opposite each other and extend parallel to each other. In the first preferred embodiment, the direction in which the first lateral wall 4a and the second lateral wall 4b are connected to each other is defined as the longitudinal direction. The first flexible member 6 and the second flexible member 7 each extend in the longitudinal direction.

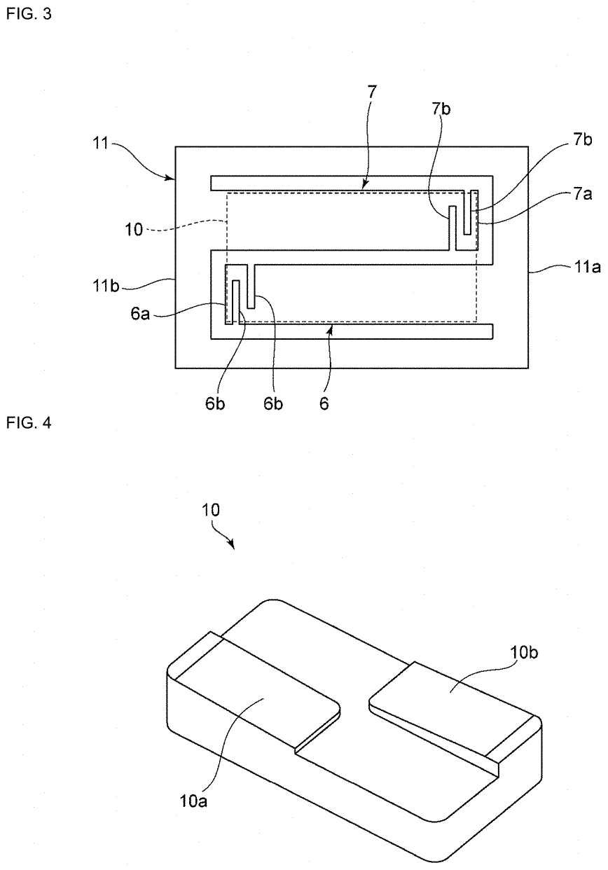

FIG. 3 is a plan view of the first flexible member, the second flexible member, and a supporting member included in the vibrating device according to the first preferred embodiment of the present invention. The vibrating device 1 includes a supporting member 11. Referring to FIG. 3, the first flexible member 6, the second flexible member 7, and the supporting member 11 will now be described.

As illustrated in FIG. 3, the supporting member 11 has a rectangular frame shape. The first flexible member 6, the second flexible member 7, and the supporting member 11 are integrated into a single member. The first flexible member 6, the second flexible member 7, and the supporting member 11 are obtained by, for example, processing a metal plate or the like.

The supporting member 11 includes a first side portion 11a and a second side portion 11b. The first side portion 11a and the second side portion 11b are located opposite each other and extend parallel to each other.

One end of the first flexible member 6 is connected to the first side portion 11a. The one end of the first flexible member 6 is supported by the supporting member 11. The other end of the first flexible member 6 is referred to as distal end 6a and is a free end. That is, the first flexible member 6 is a cantilever. The first flexible member 6 has a plurality of recesses 6b near the distal end 6a thereof.

One end of the second flexible member 7 is connected to the second side portion 11b. The one end of the second flexible member 7 is supported by the supporting member 11. The other end of the second flexible member 7 is referred to as distal end 7a and is a free end. That is, the second flexible member 7 is a cantilever. The second flexible member 7 has a plurality of recesses 7b near the distal end 7a thereof. The plurality of recesses 6b and 7b do not necessarily need to be provided.

When the first piezoelectric element 8 and the second piezoelectric element 9 are activated, the first flexible member 6 and the second flexible member 7 vibrate such that a portion of the first flexible member 6 inclusive of the distal end 6a and a portion of the second flexible member 7 inclusive of the distal end 7a are displaced up and down.

The vibrating device 1 includes a mass member 10. The mass member 10 is joined to the distal end 6a of the first flexible member 6 and to the distal end 7a of the second flexible member 7.

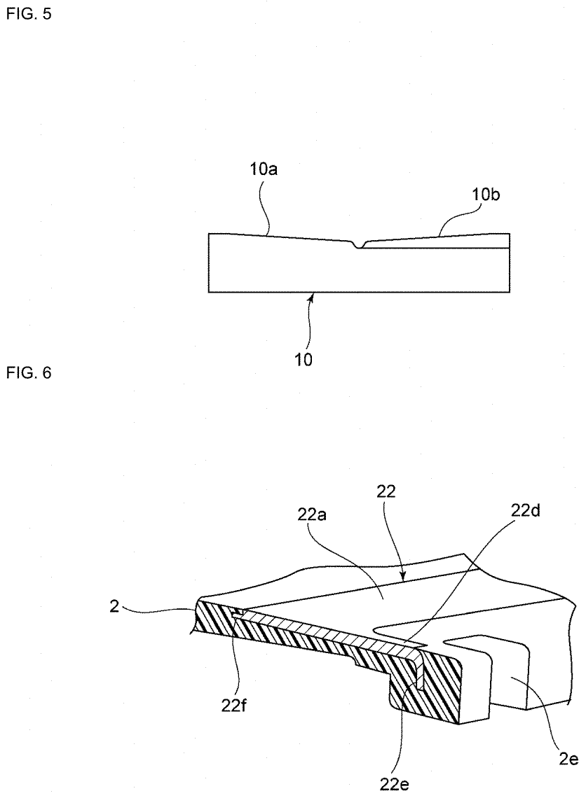

FIG. 4 is a perspective view of the mass member included in the vibrating device according to the first preferred embodiment of the present invention. FIG. 5 is a front view of the mass member included in the vibrating device according to the first preferred embodiment of the present invention. The mass member 10 includes a joining portion 10a, to which the first flexible member is joined, and a joining portion 10b, to which the second flexible member 7 is joined. The lower surface of the first flexible member 6 is joined to the joining portion 10a. The lower surface of the second flexible member 7 is joined to the joining portion 10b. With the up-and-down displacement of the portion of the first flexible member 6 inclusive of the distal end 6a and the portion of the second flexible member 7 inclusive of the distal end 7a, the mass member 10 is displaced up and down.

The case of the vibrating device 1 that includes the first case member 2 and the second case member 3 has a high mechanical strength. Such a feature will now be described in detail with reference to FIGS. 1 and 2.

The vibrating device 1 includes first terminals 12 and 13. The first terminals 12 and 13 are connected to a point having a grounding potential. The first terminals 12 and 13 are integrated with the supporting member 11 and the lateral wall member 4 by insert molding. The first terminals 12 and 13 are each electrically connected to one of electrodes (not illustrated) provided to a corresponding one of the first and second piezoelectric elements 8 and 9.

In the process of insert molding, the first side portion 11a and the second side portion 11b of the supporting member 11 are integrated with the lateral wall member 4. Thus, the one end of the first flexible member 6 is supported by the second lateral wall 4b, and the one end of the second flexible member 7 is supported by the first lateral wall 4a.

The vibrating device 1 includes second terminals 15 and 16. The second terminals 15 and 16 are provided on the bottom member 5. The second terminals 15 and 16 are each electrically connected to the other electrode (not illustrated) provided to a corresponding one of the first and second piezoelectric elements 8 and 9. The second terminals 15 and 16 are each made of metal and are each mechanically joined to the other electrode of the corresponding one of the first and second piezoelectric elements 8 and 9. The first terminals 12 and 13 are connected to a point having a grounding potential.

When a driving voltage is applied to the second terminals and 16, the first piezoelectric element 8 and the second piezoelectric element 9 are activated, whereby the first flexible member 6 and the second flexible member 7 vibrate. The second terminals 15 and 16 are integrated with the bottom member 5 by insert molding.

The vibrating device 1 includes a first holding member 21 and a second holding member 22. The first holding member 21 and the second holding member 22 are integrated with the first case member 2 by insert molding.

The vibrating device 1 according to a preferred embodiment of the present invention includes the first holding member 21 and the second holding member 22 to enhance the mechanical strength of the case.

The first holding member 21 and the second holding member 22 are each obtained by bending a metal plate. The first holding member 21 and the second holding member 22 may be obtained by any processing technique other than bending.

The first holding member 21 includes a top portion 21a, two lateral portions 21b, and two bottom portions 21c. The top portion 21a is in contact with the upper surface of the first case member 2. One of the lateral portions 21b is in contact with the third lateral wall 4c of the lateral wall member 4. The other lateral portion 21b is in contact with the fourth lateral wall 4d of the lateral wall member 4. The two bottom portions 21c are in contact with the lower surface of the bottom member 5. In FIG. 2, one of the two lateral portions 21b and one of the two bottom portions 21c are visible. The other of the two lateral portions 21b and the other of the two bottom portions 21c are hidden in FIG. 2 but are also configured as described above.

The second holding member 22 includes a top portion 22a, two lateral portions 22b, and two bottom portions 22c. The top portion 22a is in contact with the upper surface of the first case member 2. One of the lateral portions 22b is in contact with the third lateral wall 4c of the lateral wall member 4. The other lateral portion 22b is in contact with the fourth lateral wall 4d of the lateral wall member 4. The two bottom portions 22c are in contact with the lower surface of the bottom member 5.

The first holding member 21 and the second holding member 22 are spaced apart from each other in the longitudinal direction in which the first lateral wall 4a and the second lateral wall 4b are connected to each other. In plan view, the top portion 21a overlaps the joining portion 10a. In plan view, the top portion 22a overlap the joining portion 10b.

As illustrated in FIG. 1, the first holding member 21 and the second holding member 22 each extend from the upper surface of the first case member 2 and along the third lateral wall 4c to be in contact with the lower surface of the bottom member 5, and from the upper surface of the first case member 2 and along the fourth lateral wall 4d to be in contact with the lower surface of the bottom member 5. Consequently, the top portion 21a and the bottom portions 21c are located across the first case member 2 and the second case member 3 from each other, and the top portion 22a and the bottom portions 22c are located across the first case member 2 and the second case member 3 from each other. That is, the first case member 2 and the second case member 3 are held together by the first holding member 21 and the second holding member 22. Therefore, even if any impact or the like is applied to the vibrating device 1, the first case member 2 is less likely to be detached from the second case member 3, and the bottom member 5 is less likely to be detached from the lateral wall member 4. Thus, a satisfactorily high mechanical strength is provided to the case.

The vibrating device 1 includes the first holding member 21 and the second holding member 22. Alternatively, the vibrating device 1 may include only one of the two holding members or may include three or more holding members.

In the vibrating device 1, as illustrated in FIG. 2, the first holding member 21 is a single component in which the top portion 21a, the two lateral portions 21b, and the two bottom portions 21c are continuous with one another, and the second holding member 22 is a single component in which the top portion 22a, the two lateral portions 22b, and the two bottom portions 22c are continuous with one another. Alternatively, the first holding member 21 and the second holding member 22 may each be a pair of members each including a top portion, a single lateral portion, and a single bottom portion that are continuous with one another.

FIG. 6 is a partially sectional perspective view of the vibrating device according to the first preferred embodiment of the present invention.

As illustrated in FIG. 6, the second holding member 22 includes a projection 22d. The projection 22d extends in the longitudinal direction from the top portion 22a. The projection 22d includes an intruding portion 22e, which extends from the distal end of the projection 22d toward the bottom member 5, that is, downward. The intruding portion 22e intrudes into the first case member 2 in the thickness direction. Thus, the joining strength between the first case member 2 and the second holding member 22 is enhanced. Therefore, even if any impact is applied to the vibrating device 1 when the vibrating device 1 is dropped or vibrates, the first case member 2 is much less likely to be detached from the second case member 3. Preferably, as illustrated in FIG. 6, the intruding portion 22e extends in a direction orthogonal to the major surface of the first case member 2. The intruding portion 22e only needs to extend in a direction intersecting the upper surface of the first case member 2.

As illustrated in FIG. 6, the second holding member 22 further includes a thin portion 22f, which is located on a side of the second holding member 22 that is closer to the first holding member 21. The thin portion 22f is thinner than the top portion 22a. The upper surface of the thin portion 22f is at a lower level than the upper surface of the first case member 2. That is, the resin forming the first case member 2 is in contact with the upper surface of the thin portion 22f. In other words, the thin portion 22f is embedded in the first case member 2. Therefore, even if any impact is applied to the vibrating device 1 when the vibrating device 1 is dropped or vibrates, the first case member 2 is much less likely to be detached from the second case member 3.

The intruding portion 22e is provided at the distal end of the projection 22d. Alternatively, the projection 22d may be omitted. That is, the intruding portion 22e may be provided to the top portion 22a. The way the thin portion 22f is embedded is not limited to the one illustrated in FIG. 6, as long as the resin forming the first case member 2 is in contact with the upper surface of the thin portion 22f. For example, the lower surface of the thin portion 22f may be at a higher level than the lower surface of the top portion 22a. The first holding member 21 also includes an intruding portion and a thin portion, which are not illustrated but are configured as above.

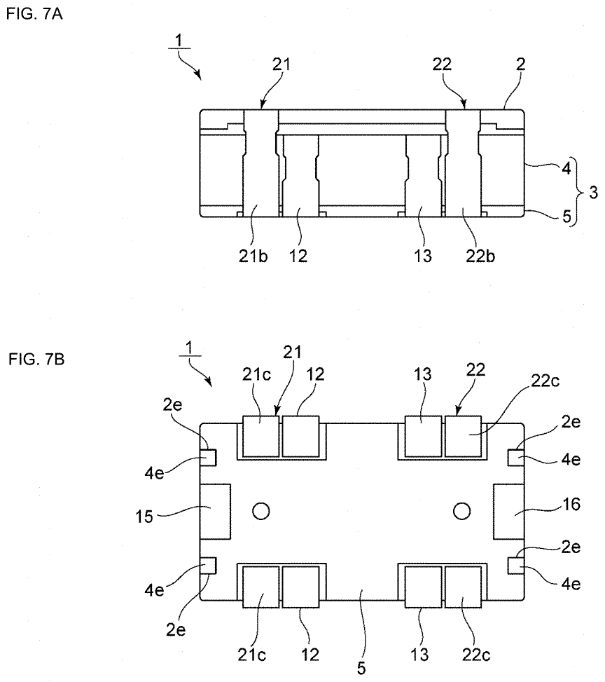

FIGS. 7A and 7B are a front view and a plan view, respectively, of the vibrating device according to the first preferred embodiment of the present invention. In the vibrating device 1, the lateral portions 21b and the bottom portions 21c of the first holding member 21 are located adjacent to the first terminal 12, while the lateral portions 22b and the bottom portions 22c of the second holding member 22 are located adjacent to the first terminal 13. The first and second holding members 21 and 22 are each made of a metal plate, which is electrically conductive. In such a case, when the vibrating device 1 is mounted on an external substrate, the bottom portions 21c and 22c and the first terminals 12 and 13 are bonded to respective lands of the external substrate by soldering or the like. That is, the bottom portions 21c and 22c define and function as mounting portions. The material for the first and second holding members 21 and 22 is not limited to metal and may be an insulative material.

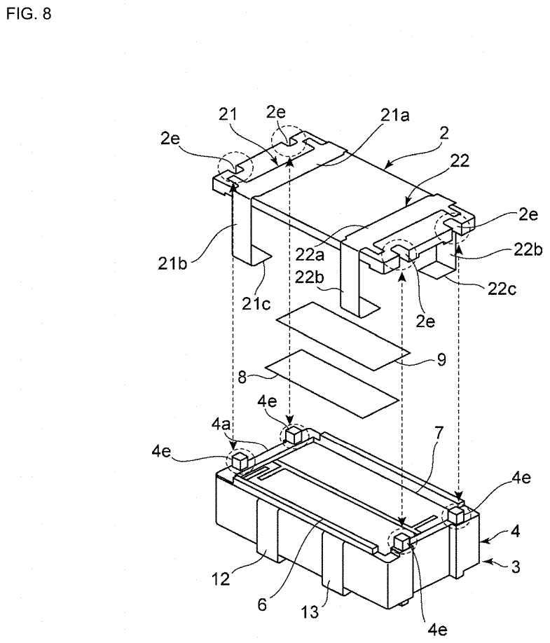

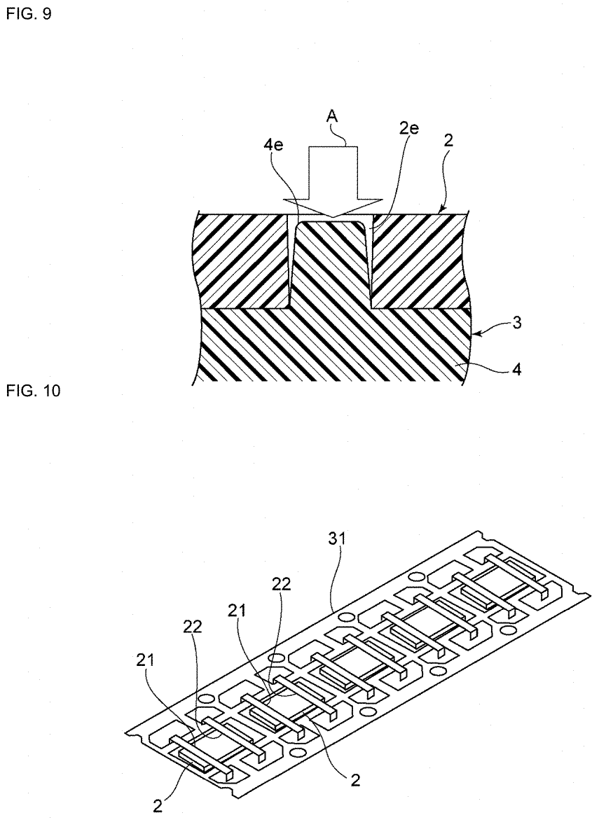

FIG. 8 is an exploded perspective view of the vibrating device according to the first preferred embodiment of the present invention. FIG. 9 is a sectional side view of a portion of the vibrating device according to the first preferred embodiment of the present invention.

The first case member 2 of the vibrating device 1 has a plurality of recesses 2e. The plurality of recesses 2e are provided at respective locations where the first case member 2 meets the first lateral wall 4a or the second lateral wall 4b. Meanwhile, the lateral wall member 4 of the vibrating device 1 has a plurality of protrusions 4e. The plurality of protrusions 4e are provided on the upper surfaces of the first lateral wall 4a and the second lateral wall 4b. As illustrated in FIG. 9, the protrusions 4e each have a tapered shape. In plan view, the recesses 2e overlap the respective protrusions 4e. Therefore, the protrusions 4e are received by the respective recesses 2e.

When the first case member 2 and the lateral wall member 4 are joined to each other, a force is applied to each of the protrusions 4e as illustrated by arrow A in FIG. 9, whereby the protrusions 4e are deformed to be fitted to the respective recesses 2e. Thus, the first case member 2 is made much less likely to be detached from the second case member 3. The protrusions 4e and the recesses 2e may be fitted to each other for tentative joining between the first case member 2 and the lateral wall member 4 in the process of assembling the vibrating device 1.

Conversely, the first case member 2 may have a plurality of protrusions, while the lateral wall member 4 may have a plurality of recesses. The numbers of protrusions and recesses are not specifically limited.

The productivity of the vibrating device 1 can be increased by, for example, using members including metal hoops illustrated in FIGS. 10 to 12 in the manufacturing process.

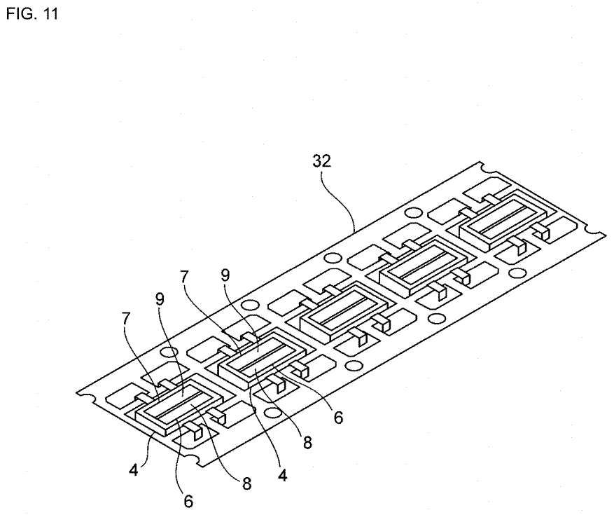

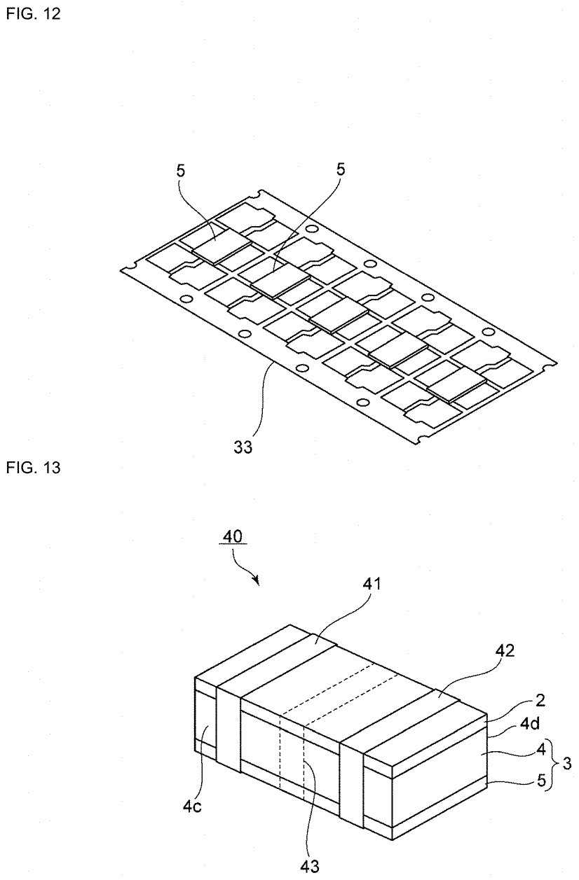

FIG. 10 is a perspective view of a first member to be used in manufacturing the vibrating device according to the first preferred embodiment of the present invention. FIG. 11 is a perspective view of a second member to be used in manufacturing the vibrating device according to the first preferred embodiment of the present invention. FIG. 12 is a perspective view of a third member to be used in manufacturing the vibrating device according to the first preferred embodiment of the present invention.

The first member illustrated in FIG. 10 includes a metal hoop 31, to which a number of structures are provided. The structures define and function as first case members 2 and first and second holding members 21 and 22 and are integrated altogether. The second member illustrated in FIG. 11 includes a metal hoop 32, to which a number of structures are provided. The structures define and function as lateral wall members 4, first and second flexible members 6 and 7, first and second piezoelectric elements and 9, mass members, and first terminals and are integrated altogether. The third member illustrated in FIG. 12 includes a metal hoop 33, to which a number of structures are provided. The structures define and function as bottom members 5 and second terminals and are integrated altogether.

The first to third members are moved to be stacked one on top of another, and the metal hoops 31 to 33 are cut off. In such a method, vibrating devices 1 can be manufactured efficiently. The method of manufacturing the vibrating device 1 is not limited to the above method.

FIG. 13 is a perspective view of a vibrating device according to a second preferred embodiment of the present invention.

As with the case of the first preferred embodiment, the vibrating device, 40, according to the second preferred embodiment of the present invention includes a first case member 2 and a second case member 3, which are assembled into a cuboidal case. The vibrating device 40 includes a first holding member 41 and a second holding member 42. The first holding member 41 and the second holding member 42 are spaced apart from each other in the longitudinal direction of the cuboidal case. The first holding member 41 and the second holding member 42 each extend across the upper surface of the first case member 2 from end to end in the width direction of the first case member 2. The first holding member 41 and the second holding member 42 each extend from the upper surface of the first case member 2 and along the third lateral wall 4c and the fourth lateral wall 4d of the lateral wall member 4 to reach the lower surface of the bottom member 5. The first holding member 41 and the second holding member 42 each also extend across the lower surface, which is hidden in FIG. 13, of the bottom member 5 from end to end in the width direction of the bottom member 5. That is, the first holding member 41 and the second holding member 42 may each have an annular shape.

Moreover, as illustrated by broken lines in FIG. 13, a third holding member 43 may be provided between the first holding member 41 and the second holding member 42. The number of holding members is not specifically limited and may be only one.

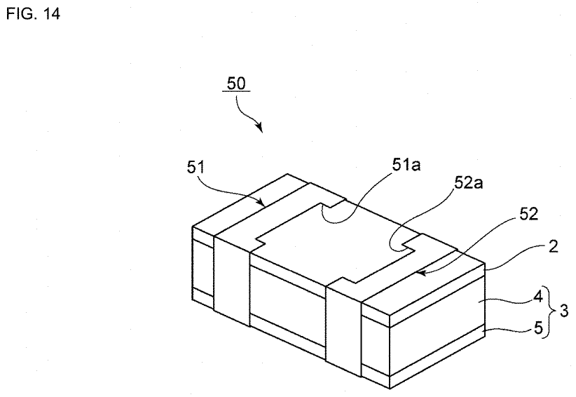

FIG. 14 is a perspective view of a vibrating device according to a third preferred embodiment of the present invention.

The vibrating device, 50, according to the third preferred embodiment of the present invention includes a first holding member 51 and a second holding member 52, which have different shapes from those of the vibrating device 40 according to the second preferred embodiment. The first holding member 51 has an indentation 51a. The indentation 51a is provided in a portion of the first holding member 51 that is in contact with the upper surface of the first case member 2 and that faces toward the second holding member 52. The second holding member 52 has an indentation 52a. The indentation 52a is provided in a portion of the second holding member 52 that is in contact with the upper surface of the first case member 2 and that faces toward the first holding member 51. Such an indentation may be provided in the holding member.

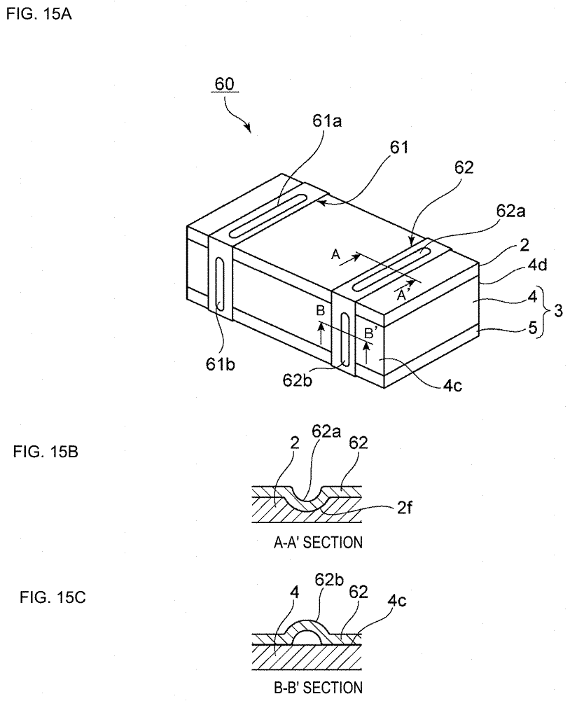

FIG. 15A is a perspective view of a vibrating device according to a fourth preferred embodiment of the present invention. FIG. 15B is a sectional view of a portion along line A-A′ illustrated in FIG. 15A. FIG. 15C is a sectional view of a portion along line B-B′ illustrated in FIG. 15A.

The vibrating device, 60, according to the fourth preferred embodiment of the present invention includes a first holding member 61 and a second holding member 62, which have different shapes from those of the vibrating device 40 according to the second preferred embodiment. The first holding member 61 has a recess 61a and a protrusion 61b. The recess 61a is provided in a portion of the first holding member 61 that is in contact with the upper surface of the first case member 2. The protrusion 61b is provided in a portion of the first holding member 61 that is in contact with the third lateral wall 4c of the lateral wall member 4.

The second holding member 62 has a recess 62a and a protrusion 62b. The recess 62a is provided in a portion of the second holding member 62 that is in contact with the upper surface of the first case member 2. The protrusion 62b is provided in a portion of the second holding member 62 that is in contact with the third lateral wall 4c of the lateral wall member 4.

As illustrated in FIG. 15B, the upper surface of the first case member 2 has a recess 2f, along which the second holding member 62 extends. Therefore, the recess 62a is formed in the second holding member 62. The recess 61a is formed in the same manner as the recess 62a.

As illustrated in FIG. 15C, the protrusion 62b includes a portion that is out of contact with the third lateral wall 4c of the lateral wall member 4. The protrusion 61b is formed in the same manner as the protrusion 62b.

The presence of the recesses 61a and 62a and the protrusions 61b and 62b provides a high mechanical strength to the first holding member 61 and the second holding member 62.

The positions of the recesses 61a and 62a and the protrusions 61b and 62b are not limited to those illustrated in FIG. 15A and may be any positions where the mechanical strength of the first holding member 61 and the second holding member 62 is desired to be enhanced.

Only one of the recesses 61a and 62a and a corresponding one of the protrusions 61b and 62b may be provided.

FIG. 16A is a perspective view of a vibrating device according to a fifth preferred embodiment of the present invention. FIG. 16B is a sectional view of a portion along line C-C′ illustrated in FIG. 16A.

The vibrating device, 70, according to the fifth preferred embodiment of the present invention includes a first case member 2, a first holding member 71, and a second holding member 72, which have different shapes from those of the vibrating device 40 according to the second preferred embodiment.

As illustrated in FIG. 16B, the first case member 2 includes a first portion 2x and a second portion 2y. The first portion 2x is located near a widthwise end of the first case member 2. The second portion 2y is located at the widthwise end of the first case member 2. The second portion 2y is thinner than the other portions of the first case member 2. The first portion 2x is thicker than the second portion 2y but is thinner than the remaining portion of the first case member 2.

The first holding member 71 includes a first portion 71a, a second portion 71b, a third portion 71c, and a fourth portion 71d. The first portion 71a is in contact with the upper surface of the first case member 2. The second portion 71b is in contact with the upper surface of the first portion 2x. The third portion 71c is in contact with the upper surface of the second portion 2y. The fourth portion 71d is in contact with the third lateral wall 4c.

The thickness, t3, of the second portion 71b is greater than the thickness, t1, of the first portion 71a and the thickness, t2, of the fourth portion 71d. The thickness, t4, of the third portion 71c is greater than the thicknesses t1, t2, and t3. Since the first holding member 71 is thick at the outer edge of the vibrating device 70, the vibrating device 70 has a high mechanical strength.

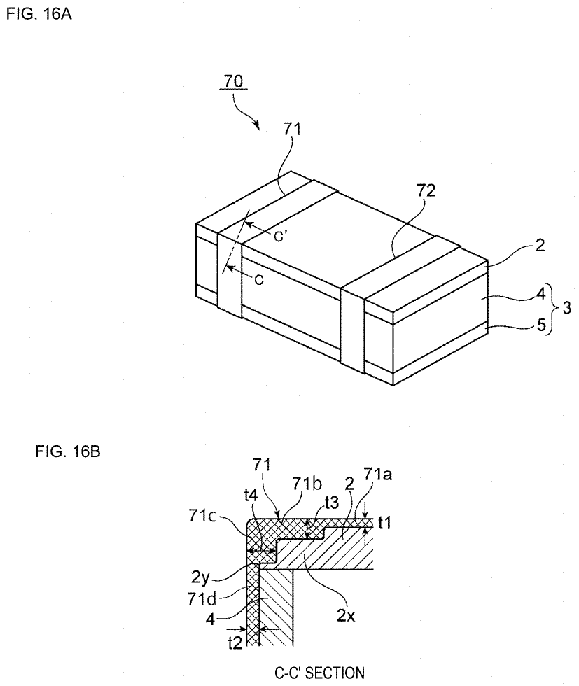

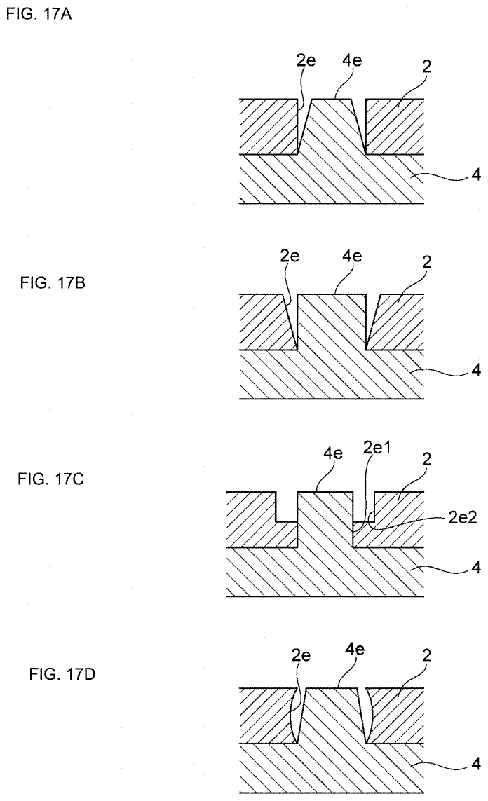

FIGS. 17A to 17D are each a sectional view of a portion of a vibrating device according to a variation of a preferred embodiment of the present invention.

In the vibrating device according to a first variation illustrated in FIG. 17A, the protrusion 4e has a tapered shape with a greater gradient than the protrusion 4e illustrated in FIG. 9. Thus, the gradient of the tapered shape may be increased.

In the vibrating device according to a second variation illustrated in FIG. 17B, the protrusion 4e has a cuboidal shape, while the recess 2e is tapered inversely. Thus, instead of the protrusion 4e, the recess 2e may be tapered inversely.

In the vibrating device according to a third variation illustrated in FIG. 17C, the protrusion 4e has a cuboidal shape, while the first case member 2 has a recess 2e1 and a recess 2e2, which are continuous with each other in the thickness direction. The recess 2e2 has a greater opening area than the recess 2e1. In plan view, the recesses 2e1 and 2e2 overlap the protrusion 4e. Therefore, the protrusion 4e is fitted to the recess 2e1, with a distal portion of the protrusion 4e being positioned in the recess 2e2. Thus, the first case member 2 may have a tiered recess.

In the variation illustrated in FIG. 17D, the protrusion 4e has a tapered shape, while the inner wall of the recess 2e is curved inward. The curved shape of the inner wall is not limited to such a shape.

As described above, the recess 2e and the protrusion 4e according to a preferred embodiment of the present invention may each have any of various shapes.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibrating device comprising:
a first case;
a second case joined to the first case;
a flexible body including a free end;
a piezoelectric element attached to the flexible body; and
a mass joined to the flexible body; wherein
the first case has a flat plate shape;
the second case includes a bottom and a lateral wall; and
the vibrating device further includes a holder in contact with the first case, the lateral wall, and the bottom.

2. The vibrating device according to claim 1, wherein the holder includes an intruding portion extending into the first case.

3. The vibrating device according to claim 2, wherein the intruding portion extends from an upper surface of the first case and in a direction intersecting the upper surface.

4. The vibrating device according to claim 1, wherein a portion of the holder is embedded in the first case and is thinner than another portion of the holder.

5. The vibrating device according to claim 1, wherein a portion of the holder overlaps a joining portion of the mass in plan view, the mass being joined to the flexible body at the joining portion.

6. The vibrating device according to claim 1, further comprising:
a first terminal; wherein
a portion of the holder is adjacent to the first terminal.

7. The vibrating device according to claim 1, wherein
the first case or the second case includes a recess; and
the second case or the first case includes a protrusion that is received by the recess.

8. The vibrating device according to claim 7, wherein the protrusion has a tapered shape.

9. The vibrating device according to claim 1, wherein the holder includes a first holder and a second holder spaced apart from each other.

10. The vibrating device according to claim 1, wherein the first case and the second case are made of synthetic resin.

11. The vibrating device according to claim 1, wherein the lateral wall has an annular shape with two openings opposite each other.

12. The vibrating device according to claim 1, further comprising another flexible body and another piezoelectric element attached to the another flexible body.

13. The vibrating device according to claim 1, wherein the lateral wall includes a first lateral wall, a second lateral wall, a third lateral wall, and a fourth lateral wall.

14. The vibrating device according to claim 1, wherein the flexible body includes a plurality of recesses at a distal end.

15. The vibrating device according to claim 9, wherein the first holder and the second holder are integrated with the first case.

16. The vibrating device according to claim 9, wherein the first holder and the second holder are defined by a bent metal plate.

17. The vibrating device according to claim 9, wherein first holder and the second holder each have an annular shape.

18. The vibrating device according to claim 9, wherein a third holder is between the first holder and the second holder.

19. The vibrating device according to claim 9, wherein each of the first holder and the second holder includes an indentation.

20. The vibrating device according to claim 9, wherein each of the first holder and the second holder includes a recess and an indentation.
